(19) United States
(12) Patent Application Publication
(10) Pub. No.: US 2024/0362464 A1
(43) Pub. Date: Oct. 31, 2024

(54) NEURAL NETWORK WITH CACHED CONVOLUTIONS FOR TIME-SERIES AND SEQUENTIAL ACTIVATION DATA AND METHODS FOR USE THEREWITH

(71) Applicant: Syntiant Corp., Irvine, CA (US)

(72) Inventors: Jeremiah H. Holleman, III, Davidson, NC (US); David Garrett, Tustin, CA (US); Youn Sung Park, Irvine, CA (US); Seongjong Kim, Trabuco Canyon, CA (US); Stephen D. Gibellini, Irvine, CA (US)

(73) Assignee: Syntiant Corp., Irvine, CA (US)

(21) Appl. No.: 18/643,121

(22) Filed: Apr. 23, 2024

Related U.S. Application Data
(60) Provisional application No. 63/498,590, filed on Apr. 27, 2023.
(60) Provisional application No. 63/519,408, filed on Aug. 14, 2023.

(51) Int. Cl. G06N 3/0464

(52) U.S. Cl. CPC G06N 3/0464

(57) ABSTRACT

A data classification engine includes an interface configured to interface with an input source, where the input source includes sequential data points representative of a time-varying input signal and one or more processors adapted to receive a temporal sequence of data points at a time T, where the one or more processors are further adapted to receive a next sequential data point and facilitate discarding an oldest data point of the temporal sequence at a time T+1. The data classification engine further includes a matrix adapted to align, at time T, to successive temporal portions of the temporal sequence to generate a set of successive outputs from the temporal sequence and one or more memory modules adapted to store the set of successive outputs from the temporal sequence. The matrix is further adapted to align at time T+1 to another successive temporal portion that includes the next sequential data point to generate a successive output, wherein the one or more processors are adapted to use the successive output and the set of successive outputs of the temporal sequence excluding a temporal sequence from the set of successive outputs that includes the oldest data point to generate another set of successive outputs.

### CROSS-REFERENCE TO RELATED APPLICATIONS

The present U.S. Utility Patent Application claims priority pursuant to 35 U.S.C. § 119(e) to U.S. Provisional Application No. 63/498,590, entitled “NEURAL NETWORK ARCHITECTURE”, filed Apr. 27, 2023, and U.S. Provisional Application No. 63/519,408, entitled “NEURAL NETWORK WITH CACHED CONVOLUTIONS FOR TIME-SERIES AND SEQUENTIAL ACTIVATION DATA AND METHODS FOR USE THEREWITH”, filed Aug. 14, 2023, both of which are hereby incorporated herein by reference in their entirety and made part of the present U.S. Utility Patent Application for all purposes.

### FIELD OF THE DISCLOSURE

The subject disclosure relates to circuits, systems and methods for artificial intelligence applications and specifically for artificial neural networks.

### BRIEF DESCRIPTION OF THE DRAWINGS

Reference will now be made to the accompanying drawings, which are not necessarily drawn to scale, and wherein:

FIG. 1 is a pictorial block diagram of a neural network core architecture in accordance with various aspects described herein;

FIG. 2 provides an example hardware operations mapping table for a neural network in accordance with various aspects described herein;

FIG. 3A illustrates caching of convolutions for time-dependent activation data in accordance with various aspects described herein;

FIG. 3B illustrates an overview of a process for classifying a data input in accordance with various aspects described herein; and

FIG. 3C illustrates an overview of a process for incrementally classifying a data input in accordance with various aspects described herein;

FIG. 3D is a flow diagram of an example method for incrementally classifying a data input in accordance with various aspects described herein;

FIG. 3E is another flow diagram of an example method for incrementally classifying a data input in accordance with various aspects described herein;

FIG. 4 illustrates an example relationship between memory architecture and coordinated state machine functions in a neural network core in accordance with various aspects described herein;

FIGS. 5A-5C illustrate representations of example memory structures for a cached convolution in accordance with various aspects described herein;

FIG. 6A illustrates an example of computing activations from continuous and real-time data in accordance with various aspects described herein;

FIG. 6B illustrates another example of computing activations from continuous and real-time data in accordance with various aspects described herein;

FIG. 6C is a flow diagram of an example method for computing activations from continuous and real-time data in accordance with various aspects described herein;

FIG. 7A illustrates an example of computing activations from continuous and real-time data in accordance with various aspects described herein;

FIG. 7B illustrates another example of computing and caching activations from continuous and real-time data in accordance with various aspects described herein;

FIG. 7C illustrates another example of computing activations from continuous and real-time data in accordance with various aspects described herein;

FIG. 7D illustrates another example of computing activations from continuous and real-time data in accordance with various aspects described herein; and

FIG. 7E is another flow diagram of an example method for computing activations from continuous and real-time data in accordance with various aspects described herein.

### DETAILED DESCRIPTION OF THE FIGURES

One or more examples are now described with reference to the drawings. In the following description, for purposes of explanation, numerous details are set forth in order to provide a thorough understanding of the various examples. It is evident, however, that the various examples can be practiced without these details.

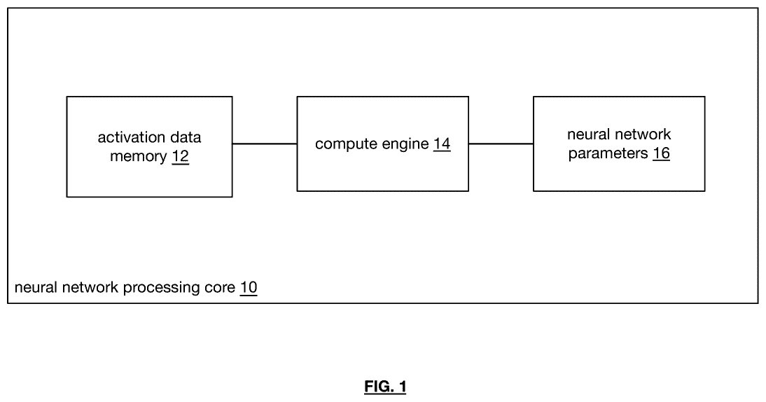

FIG. 1 is a pictorial block diagram of an example neural network core architecture. In an example, neural network processing core 10 includes activation data memory 12 adapted to store activation and/or input data for the processing by compute engine 14. In an example of implementation and operation, activation data memory 12 can be configured to receive input activation data and output activation data. In a specific example, activation data memory 12 can comprise single-port Synchronous Random Access Memory (SRAM). The single-port SRAM can be described as having one enable input and one write input, allowing only one memory word to be read or written during a given clock cycle. In a related example, the single port SRAM can be adapted to provide maximum density in the neural network processing core 10, while operating at relatively low power. In an example, a plurality of operands can be processed in a single clock cycle.

In an example of implementation, computation elements, including hardware operators such as neural network parameters 16 can be co-located with the memory. In an example of implementation, instructions can be compiled using a packaging engine and stored as the available instruction set, for example as neural network parameters 16. In a related example, a wide bus can be provided to reduce power required to access the memory. In another related example, hardware computation elements can be configured to enable deterministic processing of input data.

In an example of implementation and operation, the neural network core architecture of FIG. 1 can be adapted to provide relatively high performance while reducing the cost of the core and simultaneously reducing power requirements.

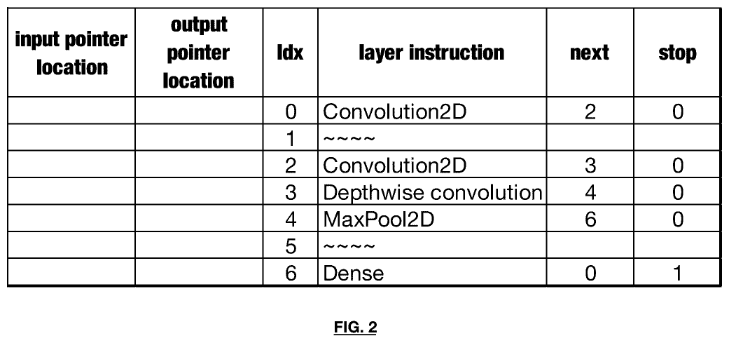

FIG. 2 provides an example hardware operations mapping table for a neural network. In an example of implementation, logic can be adapted to utilize standard operation layers as primitive operators for a convolutional neural network. In an example of implementation, hardware neural network operations can be configured to map directly to standard operators. In a related example of operation, specialized programming of hardware operations can be reduced or substantially eliminated by using standard operation layers.

Referring to FIG. 2, a method for execution of a convolutional neural network begins by a compute engine obtaining input data. The input data can be identified based on, for example, an input pointer, a first-in first-out queue, and/or a deterministic function. Example compute engines include optimized logic, field programmable gate arrays, programmable logic devices, state machines, logic circuitry and/or any devices adapted to manipulate input data based on hard coding of the circuitry and/or operational instructions. Example input data can be a portion of an input sequence, such as a data sequence from streaming data, data from a microphone, image sensor, or other sensor, or any other definable data field. The method continues by obtaining an operation instruction for the input data. In an example, an operation instruction can be an operation type, a standard operation, a layer instruction or another relevant mathematical operation or function. In a related example, an operation instruction can comprise a single instruction or an addition of two or more instructions. In an example, operation instructions can be stored in a same memory with input data and/or output data.

In a specific example of implementation, one or more operation instructions can comprise the details of a convolution exercise, so that, for example, a state machine can process a sequence of operations to execute the convolution exercise. In a related example, a convolution comprising a number of multiplies can be processed in a single clock cycle, limited only by the processing hardware. Said another way, a state machine can be adapted to provide a plurality of convolution operands with given input data for multiplication (the state machine partitions the convolution into specific operands to multiply together).

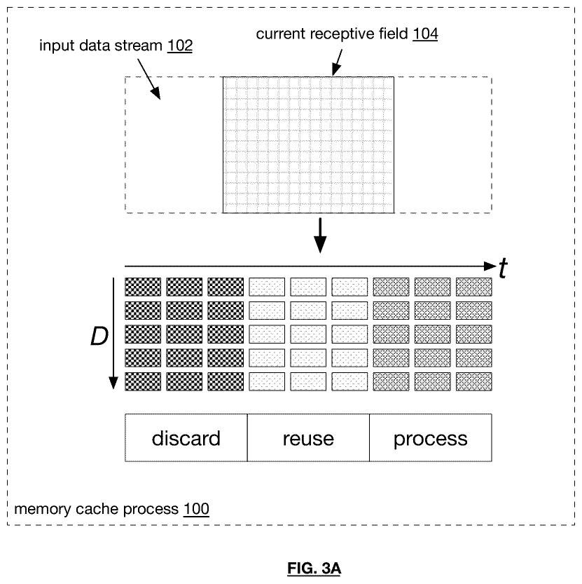

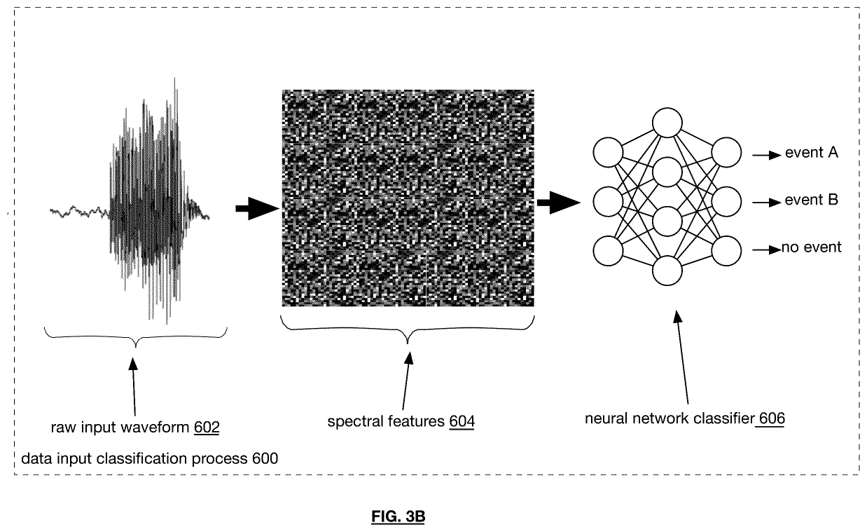

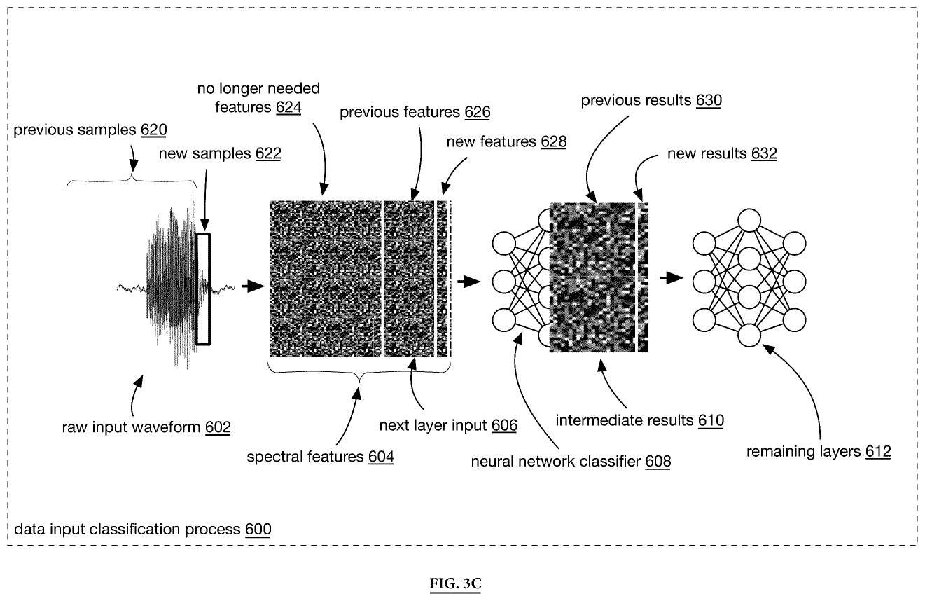

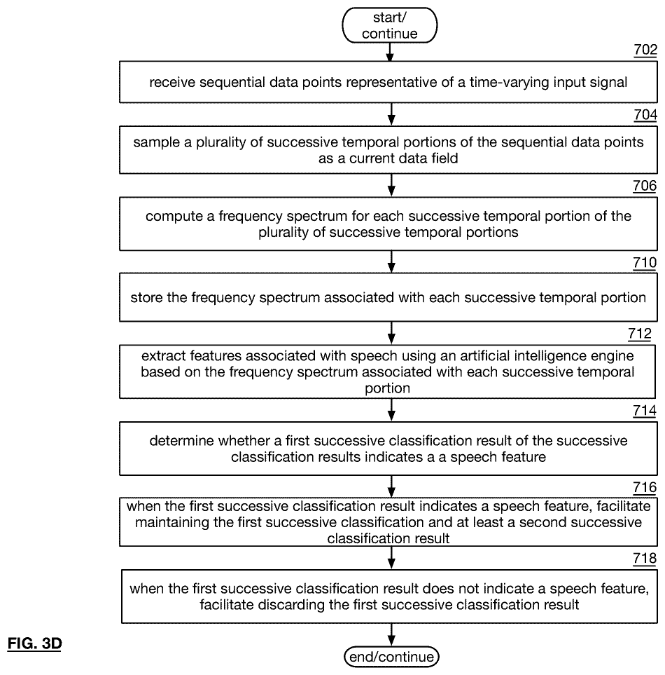

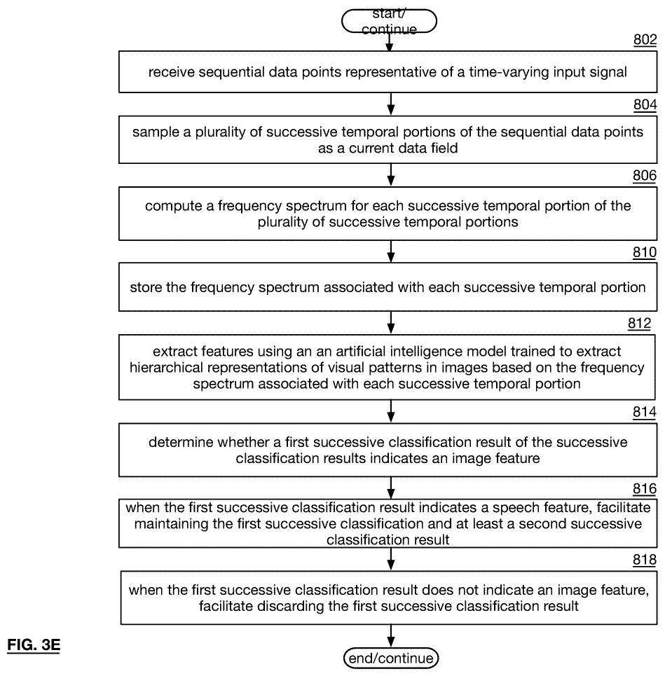

FIG. 3A illustrates caching of convolutions for time-dependent activation data. In the example, data processed using convolution mathematical operations is cached in memory for a period of time until it is either discarded or recycled for use in a classification or other processing exercise.

In various examples, a convolutional neural network architecture can be specifically designed for processing and/or classifying data structured as one-dimensional or multi-dimensional arrays, such as images, speech, auditory, acoustic or other sequences. In several examples, a convolutional neural network can be used for computer vision tasks, such as image classification, object detection, segmentation, and/or audio tasks such as wake-word detection, event detection, and more. In other nonlimiting examples, convolutional neural networks can be used to execute additional tasks, such as regression exercises for speech enhancement, sequence classifications for speech recognition and signal generation. In an example, a convolutional neural network can be configured to receive an input image or sequence, such as input data stream 102 illustrated in FIG. 3A. In an example relevant to images, input data stream 102 can consist of a grid of pixels, where each pixel contains color information, such as red, green, blue (RGB) channels, hyperspectral information and/or grayscale intensity. In other examples, input data stream 102 can comprise sequences represented as a series of tokens, such as words in natural language processing tasks.

In a specific example of implementation and operation, a convolutional neural network can be adapted to process continuous and real-time (streaming) data, such as input data stream 102, that arrives in a sequential manner, rather than being available as a fixed dataset. As discussed in further detail below, an example of processing streaming data includes a defined, fixed window adapted to continuously “slide over” an incoming data stream. In the example, at a predetermined time step the sliding window captures a segment of input data stream 102, while the computational engine can be configured to process each fixed-size segment as if it were a single input.

Referring again to FIG. 2, a convolutional neural network can comprise a plurality of standard layers, where a standard layer is configured with one or more selectable standard operators as primitive mathematical operators. In an example, the convolutional neural network includes kernels that can be adapted to be relatively small spatially and slide across an input image (or sequence), such as input data stream 102, to implement a convolution. In an example of operation, using one or more convolutional layers, a convolutional neural network can include one or more fully connected layers. In a specific example, fully connected layers of a convolutional neural network are configured to connect every neuron in the previous layer to every neuron in a subsequent layer and can be used to render predictions based on extracted features.

Referring to FIG. 3A, the current receptive field 104 includes the region in the input data stream 102 that the convolutional neural network is processing. In an example of operation, the current receptive field can include a stream of potentially classifiable inputs representing speech. In another example the current receptive field can be a stream of potentially classifiable inputs representing images and/or video. In an example, the current receptive field can include inputs representing virtually any time-dependent phenomenon.

In a related example, input samples can be processed incrementally, with the computed activations cached in a buffer so that the previously computed activations can be used to return results in a streaming fashion. In yet another example of operation, recycling previously computed convolutions can provide savings of both time and power for neural network operation. In an example, a receptive field, such as current receptive field 104, can be defined as a region of a given input data, such as input data stream 102 that a particular neuron (or feature) in a neural network can “see” or consider when making predictions.

Receptive fields, such as current receptive field 104, can be determined by the size and number of convolutional layers in the network and can define how a neural network processes and learns from input data, such as input data stream 102. In an example, by increasing a given receptive field, a network can capture larger spatial contexts and complex patterns. In a related example, each layer of a convolutional neural network applies convolutional filters to its input, increasing the receptive field compared to the previous layer. In a further example, a neural network configured with multiple layers will necessarily result in larger receptive fields of neurons in the final layers. In an example, by increasing the receptive field, neurons can enable capturing a larger spatial context and/or increasingly complex patterns.

In an example of implementation and operation illustrated in FIG. 3A, previously computed activations can be cached in a D×t matrix, where the current receptive field is a window moving with time t. In an example, computed convolutions can be held in the cache for a predetermined period of time before being eligible for either discarding or being used in a subsequent layer.

FIG. 3B illustrates an overview of a process for classifying a data input. In the example, spectral features 604 are extracted from a raw input waveform 602. Raw input waveform 602 can be any input, such as, one or more of video, speech, auditory, acoustic or other sequences. In an example, spectral features 604 can comprise raw input waveform 602 extracted to provide frequency domain features from the raw input waveform 602. In the example, a neural network classifier 606 is provided to classify spectral features 604 illustrated as, in the example of FIG. 3B as event A, event B and/or no event. In an example, the number of classification events is limited only by the relevant training of neural network classifier 606. In an example, events could be spoken words, glass breaking, or falling motions sensed by an accelerometer, among myriad other possibilities.

FIG. 3C illustrates an overview of a process for incrementally classifying a data input. In the example, raw input waveform 602 is a time-dependent analog waveform that can be characterized as including progressively older samples (previous samples 620) and new samples 622. In an example, spectral features 604 include previous features which are potentially still needed for subsequent computations and no longer needed features 624 extracted from previous samples received as raw input waveform 602. In an example, next layer input 606, comprising features extracted from new samples 622 can be processed temporally using neural network classifier 608 and cached as intermediate results 610. In an example, relevant to FIG. 3C, a neural network can be configured to be “streaming aware”, allowing for substantially real time response, high accuracy and a desirable user experience. In the example, the neural network receives a portion of input information, such as raw input waveform 602 and processes it incrementally to return an output (for example a classification result).

A method for execution by one or more processing modules of one or more computing devices, the method comprises:

FIG. 3D is a flow diagram of an example method for incrementally classifying a data input. The method begins at step 702, with one or more processing modules of one or more computing devices receiving, via an interface of the one or more computing devices configured to interface with an input source, sequential data points representative of a time-varying input signal and continues at step 704, with the one or more processing modules sampling a plurality of successive temporal portions of the sequential data points as a current data field. The method then continues at step 706, by computing a frequency spectrum for each successive temporal portion of the plurality of successive temporal portions and storing the frequency spectrum associated with each successive temporal portion in one or more memory modules associated with the one or more computing devices. In a specific example, the frequency spectrum can be represented as a frequency domain representation of the audio signal, such as Mel-frequency cepstral coefficients (MFCCs), filter banks, or spectrograms. At step 706 the method continues by classifying, via an artificial intelligence model trained to extract features associated with speech, based on the frequency spectrum associated with each successive temporal portion, to provide successive classification results and then at step 710, by storing the store the frequency spectrum associated with each successive temporal portion.

At step 712, the method continues by determining whether a first successive classification result of the successive classification results indicates a first speech feature and at step 714, in response to a determination that the first successive classification result indicates a first speech feature, at step 716, the method facilitates maintaining the first successive classification and at least a second successive classification result in the one or more memory modules. When the first successive classification result does not indicate a first speech feature the method at step continues at step 718 by facilitating discarding the first successive classification result from the one or more memory modules.

FIG. 3E is a flow diagram of an example method for incrementally classifying a data input. The method begins at step 802, with one or more processing modules of one or more computing devices receiving, via an interface of the one or more computing devices configured to interface with an input source, sequential data points representative of a time-varying input signal and continues at step 804, with the one or more processing modules sampling a plurality of successive temporal portions of the sequential data points as a current data field. The method then continues at step 806, by computing a frequency spectrum for each successive temporal portion of the plurality of successive temporal portions and storing the frequency spectrum associated with each successive temporal portion in one or more memory modules associated with the one or more computing devices. At step 808 the method continues by classifying, via an artificial intelligence model trained to extract hierarchical representations of visual patterns in images, the frequency spectrum associated with each successive temporal portion to provide successive classification results and then at step 810, by storing the frequency spectrum associated with each successive temporal portion.

At step 812, the method continues determining whether a first successive classification result of the successive classification results indicates an image feature. In a specific example of implementation, an image feature can be one or more of an object, a predetermined image classification, or an image activity marker. At step 814, in response to a determination that the first successive classification result indicates an image feature, at step 816, the method facilitates maintaining the first successive classification and at least a second successive classification result in the one or more memory modules for subsequent image classification operations. When the first successive classification result does not indicate a first speech feature, at step 818 the method continues by facilitating discarding the first successive classification result from the one or more memory modules.

In an example of implementation and operation, an example data classification engine includes an interface configured to receive sequential data points representative of a time-varying input signal. In an example, the data classification engine can be configured to receive raw audio waveforms, preprocessed wave forms and/or data points from activation memory, such as an activation memory cache. The data classification engine can include one or more processors adapted to sample a plurality of successive temporal portions of the sequential data points as a current data field, where the one or more processors are further adapted to compute a frequency spectrum for each successive temporal portion of the plurality of successive temporal portions. In an example, the data classification engine includes one or more memory modules configured to store the frequency spectrum associated with each successive temporal portion and an artificial intelligence engine adapted for using an artificial intelligence model trained to extract features associated with speech from the frequency spectrum associated with each successive temporal portion. In an example, the artificial intelligence engine can be further adapted to provide successive classification results for the frequency spectrum associated with each successive temporal portion and determine thereby whether a first successive classification result of the successive classification results indicates a first speech feature. In the example, the one or more processors are adapted to facilitate maintaining the first successive classification and at least a second successive classification result in the one or more memory modules, based on a determination that the first successive classification result indicates a speech feature. The one or more processors are further adapted to facilitate discarding the first successive classification result from the one or more memory modules when the first successive classification result does not indicate one of an image feature or a speech feature. In a related example of implementation and operation, the time-varying input signal can be video and/or image data, such that the data classification engine is configured to classify the video and/or image data as further discussed with reference to FIG. 3E.

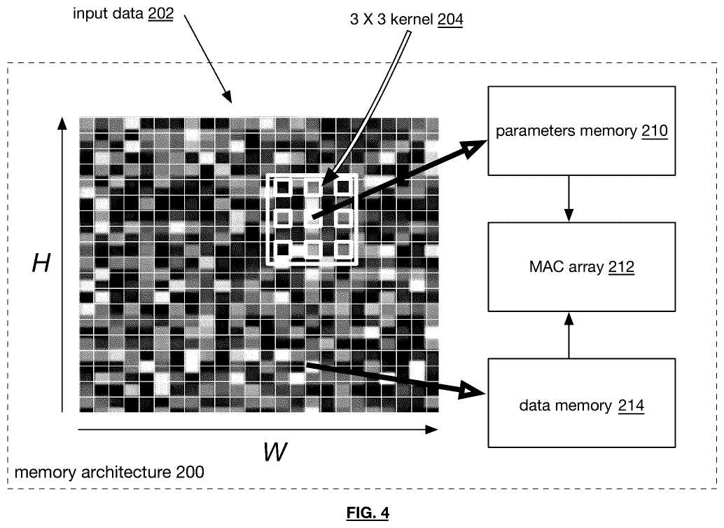

FIG. 4 illustrates an example relationship between memory architecture and coordinated processor functions in a neural network core. In an example of implementation, standard operators can be coordinated by a state machine without the use of memory offsets or other wasteful compute cycles. In a non-limiting example, standard operations can include striding functions, dilation functions and memory accesses. In an example of implementation, parameters memory 210 and data memory 214 can be provided for use directly by a processing element, such as a multiply-accumulate operator (MAC array 212) or associated logic, without requiring additional cycles or instructions to locate them in memory and/or retrieve them from memory.

In an example, a strided convolution can apply one or more standard operators to an input image or feature map with a stride value, resulting in down sampling. In a related example, a striding function can be used to reduce the spatial dimensions of a given input data while substantially preserving important features. In an example, input data for a neural processor can comprise an input image or feature map, such as input data 202 from FIG. 4, with dimensions (H_in, W_in), where H_in is the height and W in is the width. In the example, a convolutional layer consists of one or more standard operators, where each standard operator, such as 3×3 kernel 204, comprises a small spatial size (e.g., 3×3, 5×5) equal to or smaller than the input image. In various examples, the depth of the filters/kernels can be adapted to match the depth (number of channels) of the input data.

In an example of implementation, a stride can be a hyperparameter that defines a step size at which a kernel is moved over input data during convolution. In an example related to an input image, a certain number of pixels are “skipped” horizontally and/or vertically while sliding the kernel. In an example, the output dimensions of an input image after a strided convolution depend on the input dimensions (H_in, W_in), the kernel size (F), and the stride (S), where the output dimensions can be calculated as follows, where the Floor( ) operation rounds down to the next lowest integer (e.g. Floor(7/2)=3):

$$Output Height ( H\_out ) = Floor ( ( H\_in - F ) / S ) + 1$$

$$Output Width ( W\_out ) = Floor ( ( W\_in - F ) / S ) + 1$$

In a further example of implementation, a strided convolution comprises sliding the kernel over the input image using a defined stride. In a specific example, at each position an element-wise multiplication between the kernel and the corresponding portion of the input is performed for each channel, with the results summed up along with the bias term to produce a single value in the output feature map.

In an example of down-sampling, a strided convolution with a stride greater than 1 can be used to reduce the spatial resolution of an output image or feature map (as compared to the input image or feature map). By skipping locations in the process of moving the kernel, an example output feature map can have fewer elements. In an example, down-sampling can be used to reduce the computational burden for deeper layers in a neural network and increase the receptive field, potentially enabling the network to “learn” additional abstract features. In an example of implementation and operation using a repeated process of strided convolution with neural network layers, spatial dimensions of a representative feature map can provide down-sampled representations while retaining important features for classification.

In another example, down sampling can incorporate a dilated (sometimes referred to as atrous) convolution, where a kernel's spacing is increased by inserting gaps between its elements before it slides over input data. In the example, the dilation-based down-sampling effectively enlarges the receptive field of the kernel without increasing the size of the kernel itself. In various examples, resultant gaps or holes in the kernel are determined by a parameter referred to as “dilation rate”, where the dilation rate controls the spacing between the kernel elements. A dilation rate of 1 means no gaps, and the convolution behaves like a standard convolution; when the dilation rate is greater than 1, the kernel's elements are spaced apart, allowing each kernel to accommodate a larger area of input data.

In an example of implementation and operation, a computing core includes a first memory configured to store input data, a second memory configured to store neural network parameters and a third memory configured to store computation instructions. Nonlimiting example computation instructions include information sufficient for one or more compute engines to execute one or more of a striding function, a dilation function and a memory access. In an example, cache computed convolutions can be deterministically generated in response to input data. In an example, one or more hardware elements are configured to decode the computation instructions, with a fourth memory configured to cache computed activations. In another example, computation instructions can comprise a layer instruction for the computing core, where a layer includes X multiplies and Y multiplies. In a specific example, one or more hardware and/or firmware elements comprising one or more operations can be included.

In a further example, one or more compute engines are configured to operate in conjunction with the memory, such as a first, second, third and fourth memory, with the one or more compute engines being further configured to respond to input data and then classify/process the input data based upon desired neural network parameters and computation instructions. In an example, one or more compute engines can include a state machine, with the state machine being configured to divide a layer requiring some number of multiplies X into a smaller number of groups Y where all of the multiplies in a single group of the groups Y can be executed concurrently to execute a layer instruction. In another example, any of the first, second, third and fourth memory can be configured in a common memory structure.

In a related example of operation, input data can be streaming data and in a further example, input data can be a plurality of portions of an input sequence, where the one or more compute engines are configured to process a portion of the plurality of portions incrementally and return an output. In an example of implementation and operation, a convolutional neural network includes one or more a compute engines and a memory architecture. Example compute engines include, one or more multiply-accumulate operators. In an example, the memory architecture is configured for storing input data input data representative of a time-varying input signal and parameters memory in a contiguous memory structure, where the parameters memory includes a plurality of predetermined operations for the neural network. In various examples, a matrix is adapted to operate on the memory to extract one or more features from the input data based on an operation selected from the plurality of predetermined operations. In a specific example, the memory architecture includes a state machine adapted to select the operation for use by the matrix. In another example, a state machine is co-located with the memory architecture and adapted to coordinate and/or select one or more of the plurality of neural network predetermined operations directly, without requiring memory offsets and/or other wasteful compute cycles. In a specific representative example, a strided convolution for use by the neural network can provided by applying one or more of the predetermined operators to an input image, an audio waveform and/or feature map with a stride value.

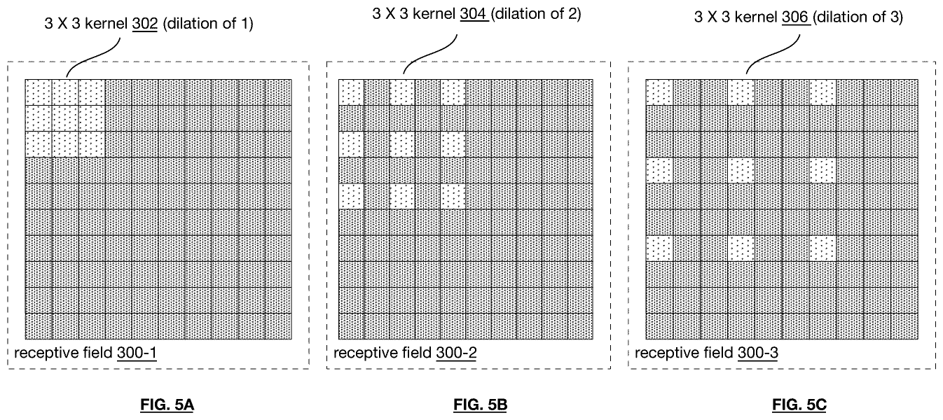

FIGS. 5A-5C illustrate representations of the memory structure for a cached convolution. In FIG. 5A, receptive field 300-1 (such as current receptive field 104 from FIG. 3A.) include 3×3 kernel 302, which is implemented with a dilation factor of 1. In the example, receptive field 300-1 is processed without gaps between 3×3 kernel 302 elements. In FIG. 5B, receptive field 300-2 includes a 3×3 kernel 304 implemented with a dilation factor of 2, providing for additional down sampling within the 3×3 kernel while processing receptive field 300-2 (such as current receptive field 104 from FIG. 3A.). In FIG. 5C, a 3×3 kernel 306 is implemented with a dilation factor of 3 within receptive field 300-1.

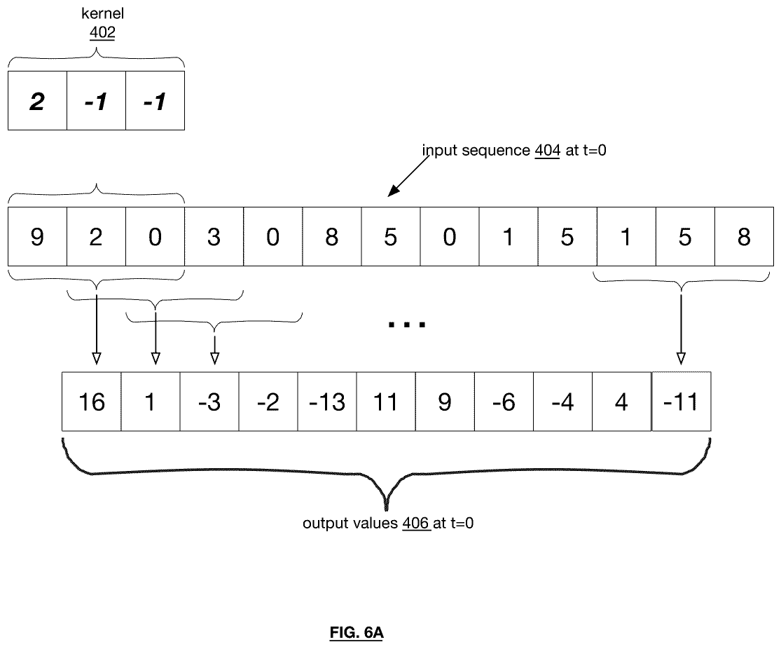

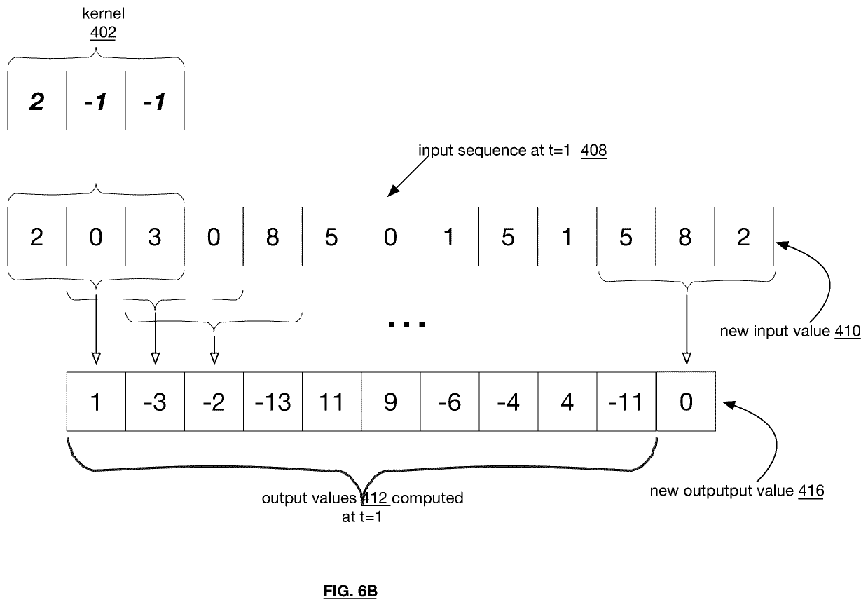

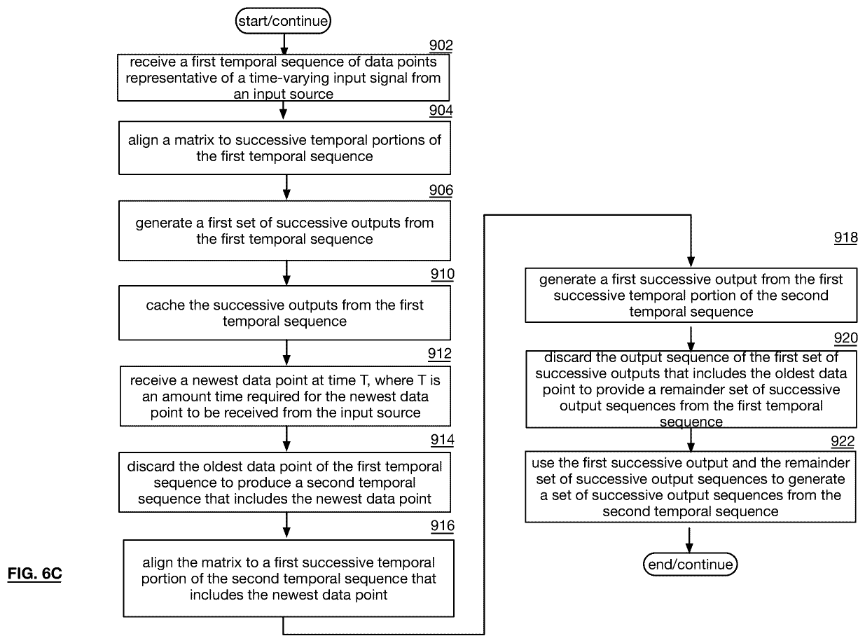

FIG. 6A illustrates an example of computing activations from continuous and real-time data. In the example, kernel 402 comprises a filter with computational parameters for a neural network. In an example, kernel 402 is aligned with a 3×1 patch of input sequence 404 and slides from oldest to newest data points of input sequence 404. Accordingly, in the example, kernel 402 operates starting at time zero (t=0) on the first corresponding elements of input sequence 404 (the first 3 elements of input sequence 404) and outputs a numerical result, where the output is the sum of products of kernel 402 and a corresponding element of input sequence 404. In the example of FIG. 6A, the output of the first corresponding element is: (2*9)+(−1*2)+(0*0)=16. Kernel 402 then “slides” along input sequence 404 incrementally to produce output values 406 at t=0 for the input sequence.

FIG. 6B illustrates another example of computing activations from continuous and real-time data. In the example, kernel 402 operates starting at t=1, where the oldest element (such as “9” from FIG. 6A) has been discarded, with a newest element (such as “2” from FIG. 6B) on the first corresponding elements of input sequence 408 at t=1 (the first updated 3 elements of the input sequence 408 at t=1) and outputs a numerical result, where the output is again the sum of products of kernel 402 and a corresponding element of the input sequence 408 at t=1. In the example of FIG. 6B, the output of the first corresponding element would be: (2*2)+(−1*0)+(−1*3)=1, which was already output at t=0. Accordingly, the output values at t=0 can be “reused” for all but the single newest element of input sequence 408 at t=1 (and after discarding the oldest element of input sequence 408 at t=1). In an example, by caching the output values determined at the earlier time interval (output values 406 at t=0), the cached output values computed at t=0 can then be used, as output values 412, instead of requiring recalculation at a subsequent time stamp for all but the new output value 416.

FIG. 6C is a flow diagram of an example method for computing activations from continuous and real-time data. The method begins at step 902, with one or more processing modules of one or more computing devices receiving, via an interface, a first temporal sequence of data points representative of a time-varying input signal. The method continues at step 904, by aligning a matrix to successive temporal portions of the first temporal sequence and generating, by the matrix, at step 906 a first set of successive outputs from the first temporal sequence. The method continues at step 910 by caching the first set of successive outputs in memory. The method then continues at step 912, by receiving, via the interface after a unit of time T, a newest data point, where T is the amount time required for the newest data point to be received from the input source and then at step 914, the method proceeds by discarding the oldest data point from the first temporal sequence to produce a second temporal sequence that includes the newest data point.

At step 916, the method continues by aligning the matrix to a first successive temporal portion of the second temporal sequence that includes the newest data point; and at step 918, by generating, using the matrix, a first successive output from the first successive temporal portion of the second temporal sequence. At step 920 the method proceeds by discarding an output sequence of the first set of successive outputs that includes the oldest data point of the first temporal sequence, to provide a remainder set of successive output sequences from the first temporal sequence and finally at step 922 the method includes using the first successive output and the remainder set of successive output sequences to generate a set of successive output sequences from the second temporal sequence.

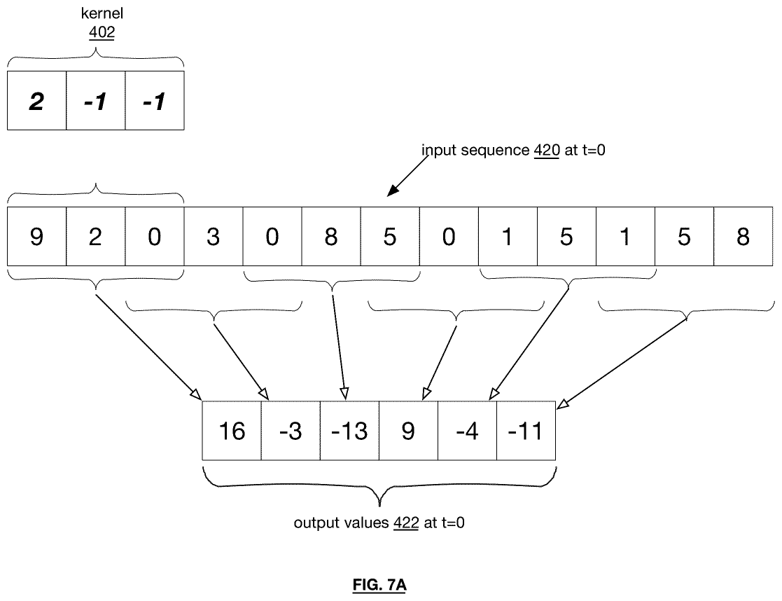

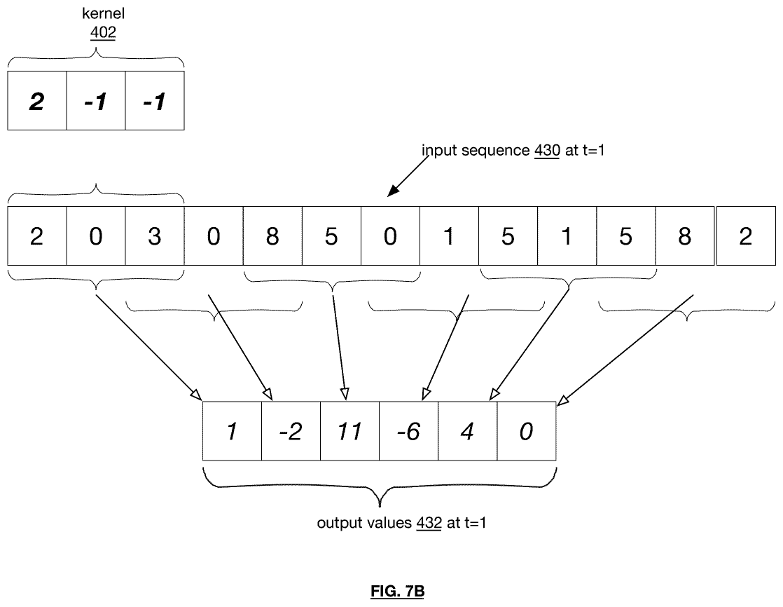

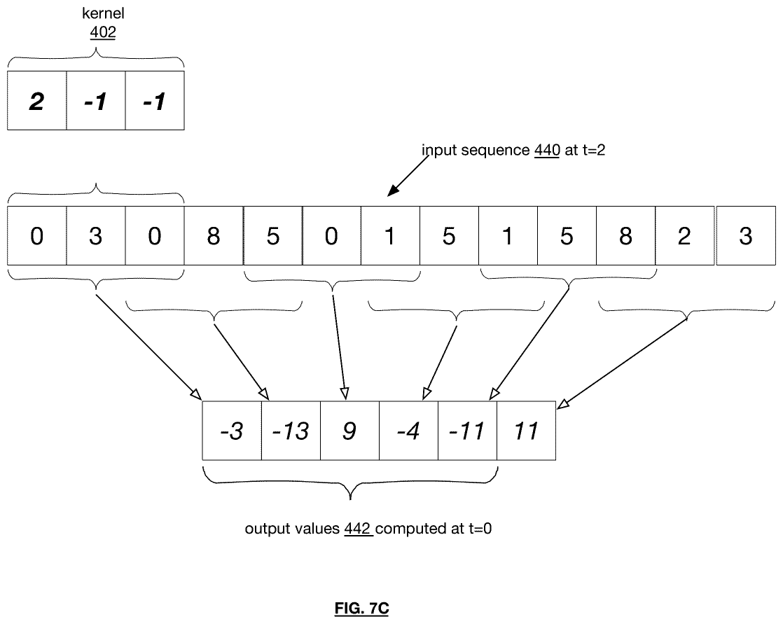

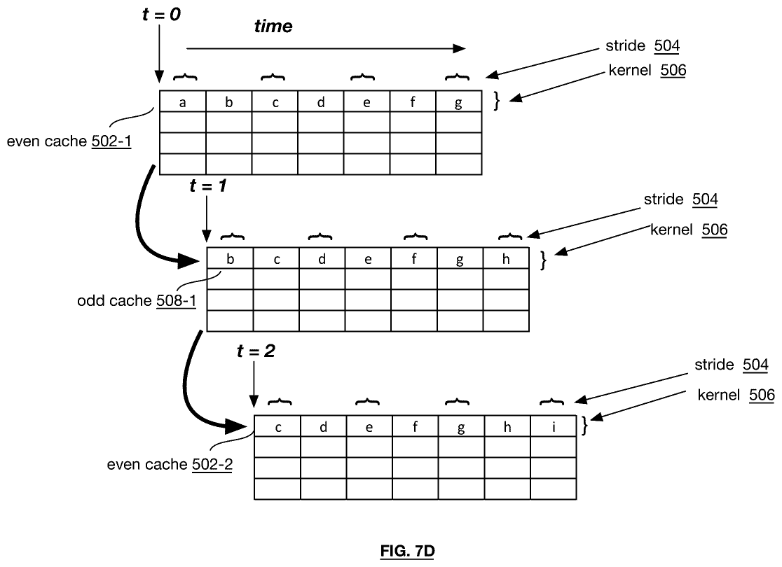

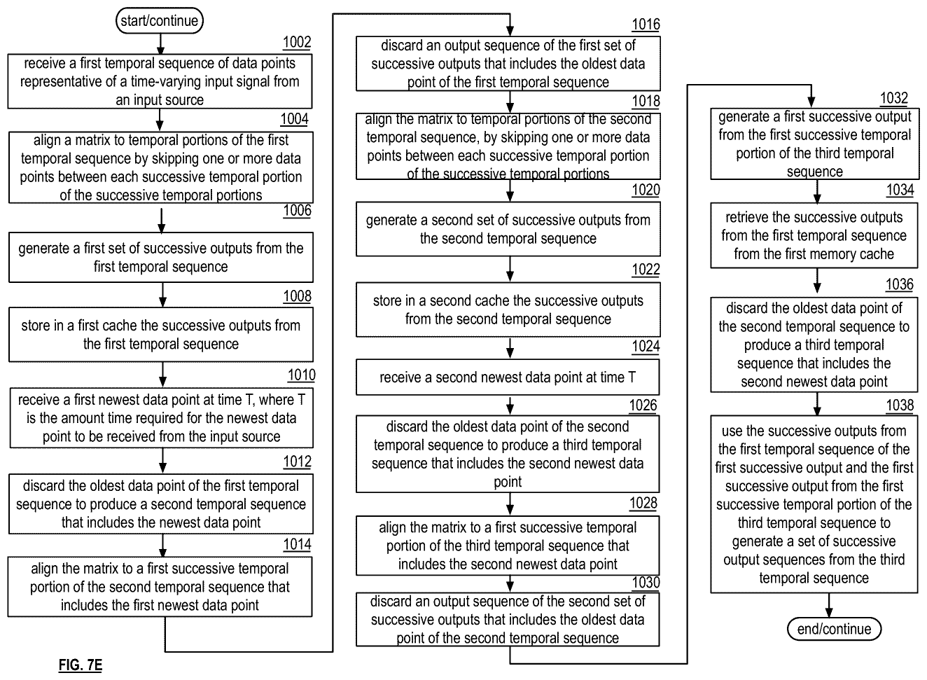

FIG. 7A illustrates another example of computing activations from continuous and real-time data. In the example, kernel 402 comprises a filter with computational parameters of an example neural network. In an example, kernel 402 is aligned with a 3×1 patch of the input sequence 420 at t=0 and skips an element each time it slides from oldest to newest data points of input sequence 420. Accordingly, in the example, kernel 402 operates starting at time zero (t=0) on the first corresponding elements of input sequence 420 (the first 3 elements of input sequence 420) and outputs a numerical result, where the output is the sum of products of kernel 402 and a corresponding element of input sequence 420. In the example of FIG. 6A, the output of the first corresponding element is: (2*9)+(−1*2)+(0*0)=16. Kernel 402 then skips an element of input sequence 420 as it “slides” along input sequence 420 incrementally to produce output values 422 at t=0 for the input sequence 420 at t=0. In an example, by caching the output values determined at the earlier time interval (output values 422 at t=0), output values 422 at t=0 for the input sequence 420 at t=0 can be cached for reuse. In an example, the output values 422 at t=0 can be stored as an “even cache”.

FIG. 7B illustrates another example of computing and caching activations from continuous and real-time data. In the example, kernel 402 now operates starting at t=1, after kernel 402 has operated at t=0, with the oldest input element (such as “9” from FIG. 7A) being discarded and a newest element (such as “2” from FIG. 7B) added) on the first corresponding elements of input sequence 430 at t=1 (the first updated 3 elements of the input sequence 430 at t=1) and outputs a numerical result, where the output is again the sum of products of kernel 402 and a corresponding element of the now input sequence 430 at t=1. In the example of FIG. 7B, the output of the first corresponding element would be: (2*2)+(−1*0)+(−1*3)=1, which was not output at t=0, however, kernel 402 then skips an element of input sequence 430 as it “slides” along input sequence 430 incrementally, to produce output values 432 at t=1 for the input sequence 430 at t=1. Accordingly, the output values 432 at t=1 are not able to be “reused” together with the values computed at t=0. In an example, the output values 432 at t=1 will necessarily requiring caching the output values at t=1 separately from the output values determined at the earlier time interval (output values 422 at t=0). In an example, the output values 432 at t=1 can be stored as an “odd cache”.

FIG. 7C illustrates another example of computing activations from continuous and real-time data. In the example, kernel 402 now operates starting at t=2, where the oldest element (“2” from FIG. 7B) has been discarded and a newest element (such as “3” from FIG. 7C added) on the first corresponding elements of input sequence 440 at t=2 (the first updated 3 elements of the input sequence 440 at t=2) and outputs a numerical result, where the output is again the sum of products of kernel 402 and a corresponding element of the new input sequence 440 at t=1. In the example of FIG. 7C, the output of the first corresponding element would be: (2*0)+(−1*3)+(−1*0)=−3, which was already output at t=0. Accordingly, the “even-time” output values 422 at t=0 can be “reused” together with the output values 442 computed at t=2. In an example, the output values 422 at t=0 and the output values 442 at t=2 can be cached together in a same cache. In an example, by using an even-time cache and an odd-time cache, reuse of previously calculated outputs can be enabled for strided convolutions.

FIG. 7D illustrates a striding example for streaming data utilizing even and odd caches. In the example, a 4×1 kernel 506 is “strided” by 2 using stride 504, so that every other sample is skipped (i.e. down-sampled). In the example, a convolution is computed at time zero (t=0) on a patch a-g, where a is the oldest sample of the patch and g is the newest sample, so that every other sample is skipped to produce eve cache 502-1. At the next time interval (t=1), the convolution exercise “slides” to the next line, adding a new sample (h) and discarding the oldest sample (a). In the example, an “even” time step generates an output to be stored in an even-time cache, such as even caches 502-1 and 502-2, while at an “odd” time step the convolution exercise generates an output to be stored in an odd-time cache, such as odd cache 508-1. In an example, when a row, as illustrated in FIG. 7D comprise two convolution layers, 4 copies of the cache can be implemented to represent the associated convolution exercise. For example, the following caches will be necessary: 1) even-even cache; 2) even-odd cache; 3 odd-even cache; and 4) odd-odd cache. In a related example, layer 1 can comprise two caches—an even cache and an odd cache—, while layer two will comprise four caches—the even-even cache, even-odd, odd-even, and the odd-odd cache. In a related example, the number of caches can be 2^{#} layers.

In an example of implementation and operation, a computing system for executing a neural network can include convolutional layers with a stride not equal to one and can be configured to store (cache) computed activations for potential re-use in the neural network. In an example, one or more circular buffers can be configured to store computed activations for re-use.

In another example of implementation and operation, a computing system for executing a neural network can be configured to store computed activations for future re-use when the neural network can include convolutional layers with non-unity striding by storing results from separate phases of the striding operation in separate caches. In a specific related example, a computing system can be configured to allocate a separate cache for each combination of striding phases. In a nonlimiting illustrative example, for a network utilizing a layer with a stride of three succeeded by a layer with a stride of two, all layers following the layer with stride of two can be configured to implement six separate activation caches: phi_1+phi_1, phi_1+phi_2, phi_2+phi_1, phi_2+phi_2, phi_3+phi_1, phi_3+phi_2.

In yet another example of implementation and operation, a computing system for executing a neural network can be configured to store computed activations for future re-use can be further configured to select one or more stored activations at the time of re-use by modifying an address buffer used to select input data for a layer. In a related example, one or more software programs can be configured to prepare executable instructions for identifying layers eligible to store computed activations for re-use. In yet another example, one or more software programs can be configured to prepare executable instructions for estimating computational and/or storage savings enabled by storing computed activations for re-use.

FIG. 7E is a flow diagram of an example method for computing activations from continuous and real-time data. The method begins at step 1002 with one or more processing modules of one or more computing devices receiving, via an interface, a first temporal sequence of data points representative of a time-varying input signal and continues at step 1004 by aligning a matrix to temporal portions of the first temporal sequence by skipping one or more data points between each successive temporal portion of the successive temporal portions. The method continues at step 1006, by generating a first set of successive outputs from the first temporal sequence and at step 1008 storing, in a first memory cache, the successive outputs from the first temporal sequence. At step 1010 a first newest data point is received, where T is the amount time required for the first newest data point to be received from the input source and at step 1012 the method continues by discarding an oldest data point of the first temporal sequence to produce a second temporal sequence that includes the first newest data point and at step 1014 by aligning the matrix to a first successive temporal portion of the second temporal sequence that includes the first newest data point.

The method continues at step 1016 by discarding an output sequence of the first set of successive outputs that includes the oldest data point of the first temporal sequence and then at step 1018, aligning the matrix to temporal portions of the second temporal sequence, by skipping one or more data points between each successive temporal portion of the successive temporal portions. The method then continues at step 1020 generating a second set of successive outputs from the second temporal sequence and at step 1022 storing, in a second memory cache, the successive outputs from the second temporal sequence. At step 1024 the method continues when a second newest data point is received and at step 1026 by discarding an oldest data point of the second temporal sequence to produce a third temporal sequence that includes the second newest data point. The method continues at step 1028 by aligning the matrix to a first successive temporal portion of the third temporal sequence that includes the second newest data point and then at step 1030 by discarding an output sequence of the second set of successive outputs that includes the oldest data point of the second temporal sequence and generating, at step 1032 a first successive output from the first successive temporal portion of the third temporal sequence. The method continues at step 1034 by retrieving the successive outputs from the first temporal sequence from the first memory cache and finally, the method contuse at step 1038 by using the successive outputs from the first temporal sequence of the first successive output and the first successive output from the first successive temporal portion of the third temporal sequence to generate a set of successive output sequences from the third temporal sequence

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences. Similarly, the phrase “real time” or “in real time” may refer to a response that is executed with a delay no more than some allowable value, where the allowable delay depends on the specific context.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module, or a logical construct in software) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more of its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that it provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such a advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining −A matches −B or not (A) matches not (B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contrary, signals to, from, and/or between elements in any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. Similarly, signals may be represented by voltages, currents, light, or other mechanisms. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e., machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A data classification engine comprises:
an interface configured to interface with an input source, wherein the input source includes sequential data points representative of a time-varying input signal;
one or more processors adapted to receive, via the interface, a temporal sequence of data points at a time T, wherein the one or more processors are further adapted to receive a next sequential data point and facilitate discarding an oldest data point of the temporal sequence at a time T+1;
a matrix adapted to align, at time T, to successive temporal portions of the temporal sequence to generate a set of successive outputs from the temporal sequence; and
one or more memory modules adapted to store the set of successive outputs from the temporal sequence; wherein the matrix is further adapted to align at time T+1 to another successive temporal portion that includes the next sequential data point to generate a successive output, wherein the one or more processors are adapted to use the successive output and the set of successive outputs of the temporal sequence excluding a temporal sequence from the set of successive outputs that includes the oldest data point to generate another set of successive outputs.

2. The data classification engine of claim 1, wherein the matrix includes one or more convolutional filters.

3. The data classification engine of claim 1, wherein the matrix is aligned at an oldest temporal portion of the successive temporal portions of first temporal sequence before generating the set of successive outputs from the temporal sequence.

4. The data classification engine of claim 1, wherein the matrix is adapted to align to each successive temporal portion of the successive temporal portions, such that the set of successive outputs includes each data point from the temporal sequence.

5. The data classification engine of claim 1, wherein the matrix is adapted to skip one or more data points between temporal portions of the successive temporal portions, such that the set of successive outputs includes less than each data point from the temporal sequence.

6. The data classification engine of claim 1, wherein the time-varying input signal is representative of series of auditory events.

7. The data classification engine of claim 1, wherein the time-varying input signal is representative of a series of images.

8. A method for execution by one or more processing modules of one or more computing devices, the method comprises:
receiving, via an interface of the one or more computing devices configured to interface with an input source, a first temporal sequence of data points representative of a time-varying input signal;
aligning a matrix to successive temporal portions of the first temporal sequence to generate a first set of successive outputs from the first temporal sequence;
caching, in memory, the successive outputs from the first temporal sequence;
receiving, via the interface after a unit of time T, a newest data point, wherein T is an amount time required for the newest data point to be received from the input source;
discarding an oldest data point of the first temporal sequence to produce a second temporal sequence that includes the newest data point;
aligning the matrix to a first successive temporal portion of the second temporal sequence that includes the newest data point; and
generating, using the matrix, a first successive output from the first successive temporal portion of the second temporal sequence;
discarding an output sequence of the first set of successive outputs that includes the oldest data point of the first temporal sequence to provide a remainder set of successive output sequences from the first temporal sequence; and
using the first successive output and the remainder set of successive output sequences to generate a set of successive output sequences from the second temporal sequence.

9. The method of claim 8, wherein the matrix includes one or more convolutional filters.

10. The method of claim 8, wherein the matrix is aligned at an oldest temporal portion of the successive temporal portions of the first temporal sequence before generating the first set of successive outputs from the first temporal sequence.

11. The method of claim 8, wherein the aligning the matrix to successive temporal portions of the first temporal sequence includes each successive temporal portion of the successive temporal portions, such that the first set of successive outputs includes each data point from the first temporal sequence.

12. The method of claim 8, wherein the aligning the matrix to successive temporal portions of the first temporal sequence includes skipping one or more data points between each successive temporal portion of the successive temporal portions, such that the first set of successive outputs includes less than each data point from the first temporal sequence.

13. The method of claim 8, wherein the time-varying input signal is representative of series of auditory events.

14. The method of claim 8, wherein the time-varying input signal is representative of a series of images.

15. A method for execution by one or more processing modules of one or more computing devices, the method comprises:
receiving, via an interface of the one or more computing devices configured to interface with an input source, a first temporal sequence of data points representative of a time-varying input signal;
aligning a matrix to temporal portions of the first temporal sequence by skipping one or more data points between each successive temporal portion of the successive temporal portions;
generating, using the matrix, a first set of successive outputs from the first temporal sequence;
storing, in a first memory cache, the successive outputs from the first temporal sequence;
receiving, via the interface after a unit of time T, a first newest data point, wherein T is an amount time required for the first newest data point to be received from the input source;
discarding an oldest data point of the first temporal sequence to produce a second temporal sequence that includes the first newest data point;
aligning the matrix to a first successive temporal portion of the second temporal sequence that includes the first newest data point;
discarding an output sequence of the first set of successive outputs that includes the oldest data point of the first temporal sequence;
aligning the matrix to temporal portions of the second temporal sequence, by skipping one or more data points between each successive temporal portion of the successive temporal portions;
generating, using the matrix, a second set of successive outputs from the second temporal sequence;
storing, in a second memory cache, the successive outputs from the second temporal sequence;
receiving, via the interface after time T, a second newest data point;
discarding an oldest data point of the second temporal sequence to produce a third temporal sequence that includes the second newest data point;
aligning the matrix to a first successive temporal portion of the third temporal sequence that includes the second newest data point;
discarding an output sequence of the second set of successive outputs that includes the oldest data point of the second temporal sequence;
generating, using the matrix, a first successive output from the first successive temporal portion of the third temporal sequence;
retrieving the successive outputs from the first temporal sequence from the first memory cache; and
using the successive outputs from the first temporal sequence of the first successive output and the first successive output from the first successive temporal portion of the third temporal sequence, generating a set of successive output sequences from the third temporal sequence.

16. The method of claim 15, wherein the matrix includes one or more convolutional filters.

17. The method of claim 15, wherein the matrix is aligned at the oldest temporal portion of the successive temporal portions of the first temporal sequence before generating the first set of successive outputs from the first temporal sequence.

18. The method of claim 15, further comprising:
receiving, via the interface after time T, a third newest data point;
discarding an oldest data point of the third temporal sequence to produce a fourth temporal sequence that includes the third newest data point;
aligning the matrix to a first successive temporal portion of the third temporal sequence that includes the third newest data point;
discarding an output sequence of the third set of successive outputs that includes the oldest data point of the third temporal sequence;
generating, using the matrix, a first successive output from the first successive temporal portion of the fourth temporal sequence;
retrieving the successive outputs of the second temporal sequence from the second memory cache; and
using the successive outputs from the first temporal sequence of the first successive output of the third temporal sequence and the first successive output from the first successive temporal portion of the fourth temporal sequence, generating a set of successive output sequences from the third temporal sequence.

19. The method of claim 15, wherein the time-varying input signal is representative of series of auditory events.

20. The method of claim 15, wherein the time-varying input signal is representative of a series of images.
